(19) United States
(12) Patent Application Publication
(10) Pub. No.: US 2013/0159205 A1
(43) Pub. Date: Jun. 20, 2013

(54) FREIGHT EVALUATION FOR AN AIRCRAFT

(71) Applicant: Airbus Operations GmbH, Hamburg (DE)

(72) Inventors: Bernd Schnörwangen, Syke (DE); Sven Scherenberger, Bremen (DE)

(73) Assignee: AIRBUS OPERATIONS GMBH, Hamburg (DE)

(21) Appl. No.: 13/756,870

(22) Filed: Feb. 1, 2013

Related U.S. Application Data
(63) Continuation of application No. PCT/EP2011/063208, filed on Aug. 1, 2011.
(60) Provisional application No. 61/369,887, filed on Aug. 2, 2010.

(30) Foreign Application Priority Data
Aug. 2, 2010 (DE) 10 2010 033 084.1

(51) Int. Cl. B64D 9/00

(52) U.S. Cl. CPC B64D 9/00
USPC 705/337; 244/137.1

(57) ABSTRACT

A freight evaluation system for providing freight information with respect to an item of freight of an aircraft includes a freight evaluation unit for collecting and analyzing data of a freight loading system and a recognition system and for determining the current position of the item of freight therefrom.

### CROSS-REFERENCE TO RELATED APPLICATIONS

This application is a continuation of International Application No. PCT/EP2011/063208, filed on Aug. 1, 2011, which claims the benefit of the filing date of German Patent Application No. 10 2010 033 084.1 filed Aug. 2, 2010, and of U.S. Provisional Patent Application No. 61/369,887 filed Aug. 2, 2010, the disclosures of which applications are hereby incorporated herein by reference.

### FIELD OF THE INVENTION

The invention relates to the monitoring of air freight. In particular, the invention relates to a freight evaluation system for providing freight information for an aircraft, an aircraft having a freight evaluation system, and a method for providing freight information with respect to a status of an item of freight of an aircraft.

### TECHNOLOGICAL BACKGROUND

In the logistics process, there may be gaps in monitoring in the field of air freight in particular. It is typical in practice to equip freight containers with data carriers. These data carriers may be manually checked and read out at established control points.

In addition, air freight container monitoring devices are known, which may be used to measure environmental conditions within an air freight container.

DE 10 2007 062 873 A1 and US 2009/0184126 A1 describe air freight containers for aircraft, which have various supply systems, such as the device for compressed air generation and compressed air provision. A control and monitoring device may be provided, which monitors the correct function of the compressed air provision.

DE 10 2005 026 898 A1 describes an aircraft freight door system for locating a plurality of cargo units (Unit Load Devices, ULDs) in an aircraft, a wireless tag being fastened on each ULD and the position of each ULD in the aircraft being calculated from the tag information.

DE 103 38 704 A1 describes a freight loading system having a sensor device for detecting a lowered or raised status of a cargo unit.

### BRIEF SUMMARY OF THE INVENTION

A freight evaluation system for providing freight information, which relates to a specific item of freight of an aircraft, an aircraft having such a freight evaluation system, and a method for providing such information are described herein.

The exemplary embodiments described hereafter relate equally to the freight evaluation system, the aircraft, and the method. In other words, features which are described hereafter with respect to the freight evaluation system, for example, may also be implemented as method steps in the method, and vice versa.

According to a first aspect of the invention, a freight evaluation system for providing freight information, which relates to a specific item of freight of an aircraft, is specified. The freight evaluation system is a freight evaluation system which is suitable for being installed and used in an aircraft. In particular, the system may be capable of withstanding the extensive pressure changes, temperature changes, and other mechanical stresses, such as the vibrations and impacts occurring during flight, without a malfunction occurring.

The freight evaluation system has a freight loading system, a recognition system, and a freight evaluation unit. The freight loading system is implemented to move a freight container, which contains the item of freight, in a freight space of the aircraft. The recognition system (with corresponding sensors) is used to provide sensor measured data, which are related to the item of freight, to the freight evaluation unit. The freight evaluation unit is coupled to the freight loading system and the recognition system so it is capable of communication therewith and is implemented to analyze the sensor measured data and further data present in the freight loading system. These further data can be control commands to the freight loading system, for example. The freight evaluation unit may comprise an interface for importing or reading in of freight papers, on which freight information is printed or otherwise provided. The interface may be connected with a processor of the aircraft, for example of the aircraft control system, and it may be provided that the freight information relating to the freight is manually imported by the freight personnel or crew. This may be performed via an infrared interface or a computer-readable medium, such as an electronic data carrier, a memory stick or a CD Rom. Furthermore, the freight evaluation system is implemented to determine a current position of the item of freight based on the collected analyzed data.

According to another aspect of the invention, the actual position of the freight in the freight space (i.e. the cargo hold) may be compared with the freight information on the freight papers or the computer-readable medium by the freight evaluation unit. Differences may then be identified and it may be provided, that specific differences are handed on, i.e. reported from one component of the system to another component of the system.

The freight papers may then be read-out together with corresponding corrections, if corrections have been carried out.

The term freight information is to be understood as a movement status of the item of freight and further parameters which are related to the status of the item of freight, in addition to the absolute position of the freight and/or relative position of the freight in the cargo space. The further parameters can be environmental conditions (such as temperature or pressure in the container), for example.

To be able to measure these data, a sensor system may be provided, which contains sensors, which are installed in the corresponding freight container and also outside the container in the cargo space of the aircraft, for example.

The freight loading system is a so-called control and conveyance system for freight and passenger aircraft, which is implemented for loading and unloading the freight space. It can be a fully automatic system in this case. It is also possible that the freight loading system is controllable via corresponding user interfaces.

The recognition system comprises the above-mentioned sensor system and receives the sensor measured data which are related to the item of freight.

The sensor measured data of the recognition system thus obtained and the data present in the freight loading system (these are control data for activating the freight container transport units, for example) are combined and processed in the freight evaluation unit. The freight evaluation unit can then determine the current position of the item of freight (relative to the surface of the earth and/or relative to the freight space) from all of these data.

According to an exemplary embodiment of the invention, the freight evaluation system further has a radio interface for transmitting the information determined by the freight evaluation unit to a terrestrial receiving station, the information determined by the freight evaluation unit being implemented to display the current position of the item of freight on a display device.

Therefore, the freight information can be transmitted at any point in time to a user located on the surface of the earth and visualized thereby.

According to a further exemplary embodiment of the invention, the freight evaluation system has a satellite navigation module for determining the current position of the aircraft, the satellite navigation module being coupled to the freight evaluation unit so it is capable of communication therewith, and the position data determined by the satellite navigation module also being used by the freight evaluation unit to determine the current position of the item of freight.

A user may thus obtain information at any point in time about where precisely the item of freight is located in the cargo space of the aircraft and/or where the item of freight is located in the airspace.

According to a further exemplary embodiment of the invention, the recognition system has optical sensors which are integrated in the drives of the freight loading system. In this way, it may be optically determined when a specific freight container passes a specific drive.

According to a further exemplary embodiment of the invention, the further data present in the freight loading system, which the freight evaluation unit analyzes to determine the current position of the item of freight, comprise travel commands, on the basis of which the freight container is moved.

The travel commands are commands which are generated by the freight loading system, for example, and are to be attributed to a user command. In this case, these can also be travel commands which are not to be attributed to a user command, but rather are generated automatically by the freight loading system.

According to a further exemplary embodiment of the invention, the freight evaluation unit is implemented to perform a function check of the freight loading system on the basis of the sensor measured data and optionally the travel commands.

For example, it may be established on the basis of the sensor measured data whether the commands of the freight loading system and/or of the user controlling the freight loading system have been executed correctly.

According to a further exemplary embodiment of the invention, the recognition system has a sensor for detecting environmental parameters, from which a status of the item of freight can be concluded. The freight evaluation system is implemented in this case to determine the status of the item of freight on the basis of the detected environmental parameters

Thus, for example, it may be measured whether the pressure and/or the temperature within a freight container has the desired value. The temperature in the container may be monitored using temperature sensors, in order to thus be able to perform refrigeration chain monitoring even during the air transport, for example. It can be recognized using light sensors, for example, whether a container has been opened. Strong shocks can be detected and logged using acceleration sensors. Gas sensors are suitable in particular for monitoring hazardous material. Another application for gas sensors comprises ripening process monitoring, for example, in the case of foods, such as ripening fruits. The humidity within the air freight container can be measured via a humidity sensor. This is advantageous in particular for freight materials which react sensitively to humidity or for freight materials which require a specific minimum humidity.

Alternatively or additionally, smoke alarms may also be used as sensors, which detect smoke in the freight container. In the case of smoke alarms in the container, a critical status or a fire in the container can already be discovered earlier in comparison to smoke detection in the freight space.

According to a further exemplary embodiment of the invention, the freight evaluation unit is implemented for providing data which allow a display of the status and the position of the item of freight at any point in time.

In particular, it may be provided that the status and the position of the item of freight can also be displayed by a terrestrial receiving station.

According to a second aspect of the invention, an aircraft having a freight evaluation system as described above and hereafter is specified.

According to a further aspect of the invention, a method for providing information which relates to a specific item of freight of an aircraft is specified. In the method, a freight container which contains the item of freight is moved in a freight space of the aircraft. Data are provided, which are present in the freight loading system (which moves the freight container). These data are transmitted to a freight evaluation system. Furthermore, sensor measured data which are related to the item of freight are detected by sensors and also transmitted to the freight evaluation unit. The analysis of the sensor measured data and the further data which are present in the freight loading system is subsequently performed by the freight evaluation unit. After the analysis, the current position of the item of freight is determined on the basis of the analyzed data.

According to a further exemplary embodiment of the invention, the information determined by the freight evaluation unit is transmitted from the aircraft to a terrestrial receiving station, upon which a display of the current position of the item of freight in the freight space is performed on a terrestrial display device. This display device receives the display data from the terrestrial receiving station.

Exemplary embodiments of the invention are described hereafter with reference to the figures.

### BRIEF DESCRIPTION OF THE DRAWINGS

FIG. 1 shows a freight evaluation system according to an exemplary embodiment of the invention.

FIG. 2 shows an aircraft having a freight evaluation system according to a further exemplary embodiment of the invention.

FIG. 3 shows a flowchart of a method according to a further exemplary embodiment of the invention.

### DETAILED DESCRIPTION

The illustrations in the figures are schematic and are not to scale.

The same reference numerals are used for identical or similar elements in the following description of the figures.

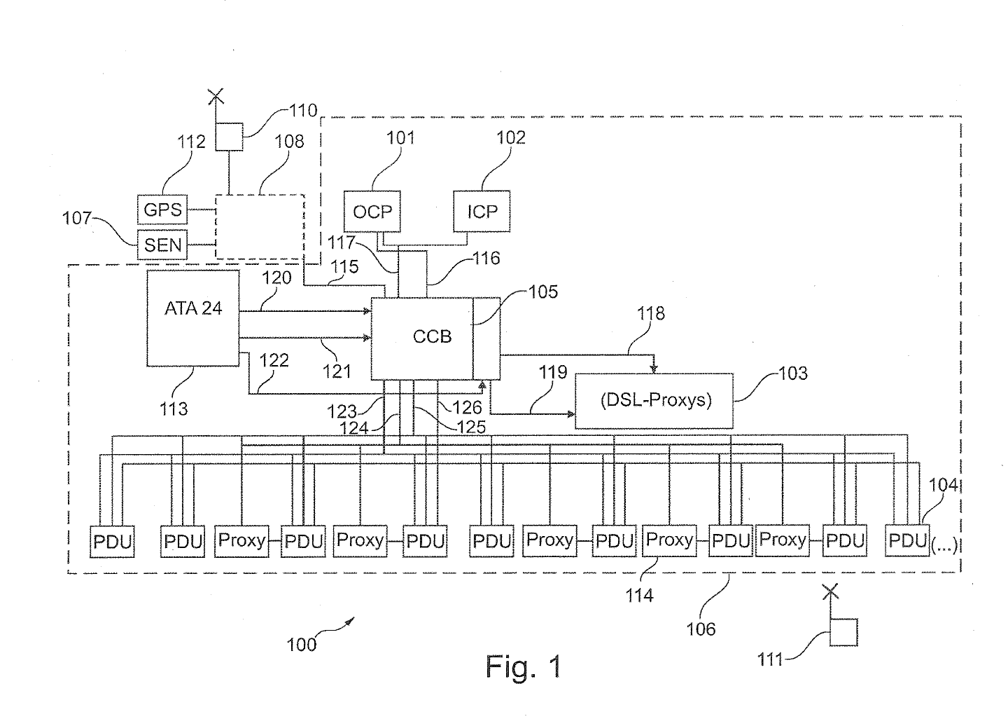

FIG. 1 shows a freight evaluation system 100 according to an exemplary embodiment of the invention. The freight evaluation system 100 has a freight loading system 106, a recognition system 107, and a freight evaluation unit 108 or at least a corresponding interface.

The freight evaluation unit 108 is supplied with, on the one hand, the sensor measured data of the recognition system 107, but also, on the other hand, specific data present in the freight loading system 106 and the position data received by the satellite navigation module 112. An interface can also be provided, which is connected to the aircraft navigation, in order to transmit the position data of the aircraft to the system. In this case, a separate navigation module is not required. The corresponding sensors can be part of the freight loading system. In this case, the recognition system is at least partially integrated in the freight loading system.

These data are then collected, bundled, and prepared in the freight evaluation unit 108. The prepared data can subsequently be transmitted by means of radio transmission by the transceiver unit 110 to a terrestrial receiving station 111. Continuous freight monitoring (with respect to the current freight position and with respect to other data detected by the sensors 107) is thus possible.

The freight loading system 106 has a cargo control unit (Cargo Control Box (CCB)) 105 as a central component. This unit controls the transport direction of the item of freight within the freight space, switches individual transport units on or off, and can recognize whether a transport unit is ready for operation.

The freight-space-external control unit 101 and the freight-space-internal control unit 102 are connected to this control unit 105 via lines 117, 116. These two control units have corresponding user interfaces, via which the loading personnel can control the loading procedure and unloading procedure.

Control commands can be issued from these control panels 101, 102, for example, the commands forward, backward, in, out, or split. The freight is moved in accordance with these commands.

To control the movement of the item of freight, the freight control unit 105 is connected via the data lines 123, 124, 125, 126 to electrical transport units (Power Drive Units, PDUs) 104. Some of these PDUs 104 are connected to corresponding proxies 114. The proxies 114 release all PDUs located behind them in the loading direction for transport. Each freight parking space is equipped with a proxy.

The direction of the freight transport may be controlled via these PDUs 104. In addition, the item of freight can be blocked or fixed. The respective PDU only transports, for example, when its optical sensor is covered and a travel signal is given.

Furthermore, so-called proximity switches 103 are provided, which are connected via the data lines 118 and the power lines 119 to the freight control unit 105.

These may detect when the loading/unloading procedure is completed or can be started.

All data may be provided to the freight evaluation unit 108 via the data bus 115.

Through the freight identification of the freight evaluation unit 108 and the bundling and processing of all data by the freight evaluation unit 108, it is possible to precisely localize freight containers and pallets in the freight space of the aircraft. In addition, still further parameters can be detected, which permit statements about the status of the item of freight (for example, whether the refrigeration chain is broken, etc.). The measured data of optical or other sensors which are provided within the drives 104, for example, and corresponding travel commands which are specified by the corresponding panels 101 (outside control panel, OCP) and 102 (inside control panel, ICP), can be fused or compared to one another. An error check is thus possible. For example, it can be established whether or not a control command has been correctly executed.

Locked freight containers are localized by the analysis of the proximity switch proxies 114 below the corresponding locking units.

The item of freight can be localized precisely in the freight space in cooperation with the freight recognition system 107. The advantage of this networking of the freight loading system 106, the recognition system 107, and the freight evaluation unit 108 is, inter alia, that incorrect loads are substantially prevented and the freight can be precisely localized up into the freight space. This precise freight localization is also possible during the flight and can be displayed to an off-board user at any time. An important element of a comprehensive logistics control for air freight may thus result.

The interface provided by the freight evaluation unit 108 makes it possible for the freight position in the freight space to be able to be displayed at any time.

In other words, the data present in the freight loading system are used for the usage and/or preparation and for the provision of these data for a freight evaluation unit via a bus interface for coupling to freight recognition systems. The freight evaluation unit bundles and processes the data present in the freight loading system with the data of the recognition system. These data are prepared so that the status and the location of the item of freight can be displayed to the customer at any time

It is shown hereafter on the basis of five tables which data can be provided by the electronic transport unit (Table 1), by the proximity switches (Table 2), by the control panel 101, which is located outside the freight space (Table 3), by the control panel 102, which is located in the interior of the freight space (Table 4), and by the freight control unit (or a monitoring unit of the freight loading system) 105 (Table 5) to the freight evaluation unit 108.

The tables show the values (bytes) of the respective freight loading components transmitted from the freight loading system via BUS to the freight evaluation system.

TABLE 1

| | | | | | | | |
|---|---|---|---|---|---|---|---|
| 7 | 6 | 5 | 4 | 3 | 2 | 1 | 0 |

| | | | | | |
|---|---|---|---|---|---|
| Hold | AFT/ | FWD/OUT | covered | uncovered | Byte 0 |
| | IN | | | | |
| | | | | | Byte 1 |
| | | | | | Byte 2 |
| | | | | | Byte 3 |

If freight is over the corresponding drive, bit 0 of byte 0 (“uncovered”)=1.

If no freight is over the drive, bit 1 of byte 0 (“covered”)=1.

If the drive transports in the respective direction (“FWD/OUT; AFT/IN”), bit 2 of byte 0=1.

If the drive holds the freight (active), bit 4 of byte 0 (“hold”)=1.

TABLE 2

| | | | | | | | |
|---|---|---|---|---|---|---|---|
| 7 | 6 | 5 | 4 | 3 | 2 | 1 | 0 |

| | | |
|---|---|---|
| covered | uncovered | Byte 0 |
| | | Byte 1 |
| | | Byte 2 |
| | | Byte 3 |

If the proxy is covered, bit 0 of byte=1.

If the proxy is not covered, bit 1 of byte=1.

TABLE 3

| | | | | | | | |
|---|---|---|---|---|---|---|---|
| 7 | 6 | 5 | 4 | 3 | 2 | 1 | 0 |

| | | | | | | |
|---|---|---|---|---|---|---|
| Split | OUT | IN | AFT | FWD | Zero | Byte 0 |
| | | | | | | Byte 1 |
| | | | | | | Byte 2 |
| | | | | | | Byte 3 |

The respective bit in whose position the joystick of the OCP is currently located is set to 1 (all other bits=0).

TABLE 4

| | | | | | | | |
|---|---|---|---|---|---|---|---|
| 7 | 6 | 5 | 4 | 3 | 2 | 1 | 0 |

| | | | |
|---|---|---|---|
| AFT | FWD | Zero | Byte 0 |
| | | | Byte 1 |
| | | | Byte 2 |
| | | | Byte 3 |

The respective bit in whose position the joystick of the OCP is currently located is set to 1 (all other bits=0).

TABLE 5

| | | | | | | | |
|---|---|---|---|---|---|---|---|
| 7 | 6 | 5 | 4 | 3 | 2 | 1 | 0 |

| | | |
|---|---|---|
| Sys inop | Sys ON | Byte 0 |
| | | Byte 1 |
| | | Byte 2 |
| | | Byte 3 |

If the freight loading system is turned on (voltage supplied), the bit “Sys ON”=1.

If the freight loading system is turned on but not ready for use, the bit “Sys inop”=1.

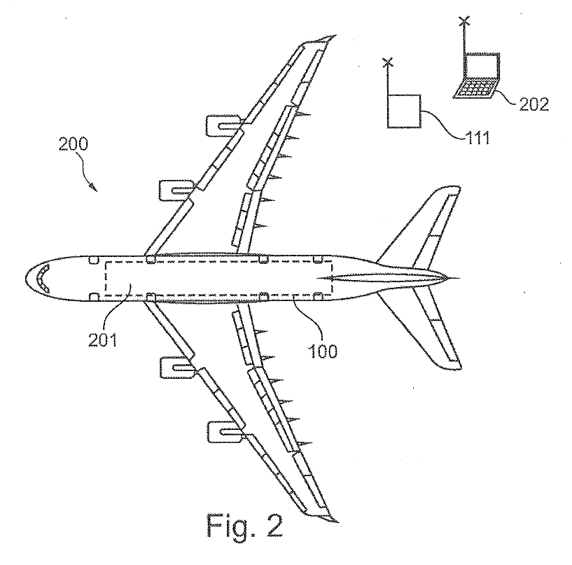

FIG. 2 shows an aircraft 200 having a freight evaluation system 100 according to an exemplary embodiment of the invention. The freight evaluation system 100 is at least partially situated in the freight space 201 of the aircraft. The aircraft is a passenger aircraft or a freight aircraft, for example.

The freight evaluation system 100 may communicate with a terrestrial receiving station 111 and transmit the generated data thereto. The receiving station 111 can also request data from the freight evaluation system 100. The receiving station 111 is coupled to a display device 202 for a user so it is capable of communication therewith. This is a mobile display device, such as a PDA or a mobile telephone, or also a stationary display device, such as a stationary logistics system, for example, in this case.

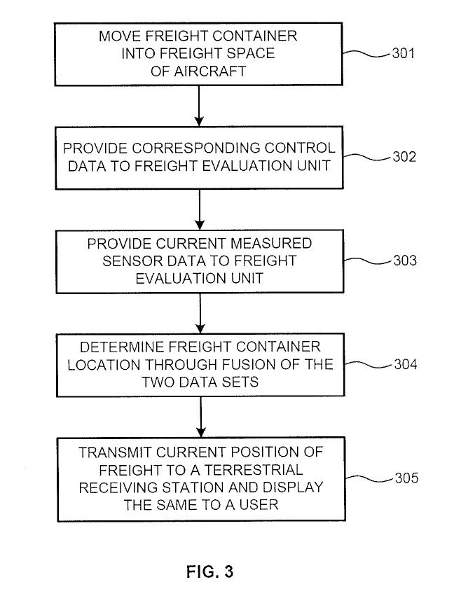

FIG. 3 shows a flowchart of a method according to an exemplary embodiment of the invention. In step 301, a freight container is moved into the freight space of the aircraft and then moved further until the container has reached its final position. In step 302, the corresponding control data are provided to the freight evaluation unit. In step 303, current measured sensor data are further provided to the freight evaluation unit. These are measured data of optical sensors, pressure sensors, or proximity switches, for example. Through the fusion of these two data sets, a concrete statement can be made about where each freight container is located at a specific point in time. This data fusion is performed in step 304. In step 305, the current position of the item of freight thus determined is transmitted to a terrestrial receiving station and displayed to a user.

It is to be noted here that the data transmission between the individual components can be performed both via wire and also wirelessly, if desired.

In addition, it is to be noted that “comprising” and “having” do not exclude other elements or steps and “a” or “an” does not exclude multiples. Furthermore, it is to be noted that features or steps which have been described with reference to one of the above exemplary embodiments can also be used in combination with other features or steps of other above-described exemplary embodiments. Reference numerals in the claims are not to be construed as a restriction.

1. A freight evaluation system for providing freight information relating to a specific item of freight of an aircraft, the freight evaluation system comprising:
a freight loading system for moving a freight container containing the item of freight, in a freight space of the aircraft;
a recognition system for providing sensor measured data related to the item of freight; and
a freight evaluation unit coupled to the freight loading system and the recognition system for communication therewith, for analyzing the sensor measured data and data present in the freight loading system;
wherein the freight evaluation unit is implemented to determine a current position of the item of freight on the basis of the analyzed data.

2. The freight evaluation system according to claim 1, further comprising:
a radio interface for transmitting the information determined by the freight evaluation unit to a terrestrial receiving station;
wherein the information determined by the freight evaluation unit is adapted to display the current position of the item of freight on a display device.

3. The freight evaluation system according to claim 1, further comprising:
a satellite navigation module for determining the current position of the aircraft, is the satellite navigation module coupled to the freight evaluation unit for communication therewith;
wherein the position data determined by the satellite navigation module are configured to be used by the freight evaluation unit to determine the current position of the item of freight.

4. The freight evaluation system according to claim 1,
wherein the recognition system comprises at least one optical sensor integrated in at least one drive of the freight loading system.

5. The freight evaluation system according to claim 1,
wherein the data present in the freight loading system comprise travel commands on the basis of which the freight container is moved.

6. The freight evaluation system according to claim 1,
wherein the freight evaluation unit is implemented to perform a function check of the freight loading system on the basis of the sensor measured data.

7. The freight evaluation system according to claim 1,
wherein the recognition system comprises a sensor for detecting environmental parameters for concluding a status of the item of freight; and
wherein the freight evaluation unit is implemented to determine the status of the item of freight on the basis of the detected environmental parameters.

8. The freight evaluation system according to claim 1,
wherein the freight evaluation unit is implemented to provide data for allowing a display of the status and the position of the item of freight at any point in time.

9. An aircraft having a freight evaluation system, the freight evaluation system comprising:
a freight loading system for moving a freight container containing the item of freight, in a freight space of the aircraft;
a recognition system for providing sensor measured data related to the item of freight; and
a freight evaluation unit coupled to the freight loading system and the recognition system for communication therewith, for analyzing the sensor measured data and data present in the freight loading system;
wherein the freight evaluation unit is implemented to determine a current position of the item of freight on the basis of the analyzed data.

10. A method for providing freight information relating to a specific item of freight of an aircraft, the method comprising:
moving a freight container containing the item of freight in a freight space of the aircraft;
providing data present in the freight loading system to a freight evaluation unit;
providing sensor measured data related to the item of freight to the freight evaluation unit;
analyzing the sensor measured data and the data present in the freight loading system; and
determining the current position of the item of freight on the basis of the analyzed data.

11. The method according to claim 10, further comprising:
transmitting the information determined by the freight evaluation unit from the aircraft to a terrestrial receiving station; and
displaying the current position of the item of freight on a terrestrial display device.
